(19) United States
(12) Patent Application Publication
(10) Pub. No.: US 2009/0027645 A1
(43) Pub. Date: Jan. 29, 2009

(54) EXPOSURE APPARATUS AND METHOD THEREOF

(76) Inventor: Ju-Hyun Kim, Cheonan-si (KR)

Correspondence Address: SHERR & VAUGHN, PLLC, 620 HERNDON PARKWAY, SUITE 200, HERNDON, VA, 20170, US

(21) Appl. No.: 12/175,728

(22) Filed: Jul. 18, 2008

(30) Foreign Application Priority Data
Jul. 23, 2007 (KR) 10-2007-0073330

(51) Int. Cl. G03B 27/52

(52) U.S. Cl. 355/67

(57) ABSTRACT

Disclosed are an exposure apparatus and a method thereof. The exposure apparatus includes a laser oscillating part which generates an incident light. A polarization part includes at least one medium, and generates a polarized light by reflecting the incident light from the medium. A light condensing part condenses the polarized light. An exposure part exposes a wafer using the polarized light condensed by the light condensing part.

The present application claims priority under 35 U.S.C. 119 to Korean Patent Application No. 10-2007-0073330 (filed on Jul. 23, 2007), which is hereby incorporated by reference in its entirety.

### BACKGROUND

To form a pattern for a gate or an interconnection when manufacturing a semiconductor device, a photolithography process must be performed. In a photolithography process, a laser beam may be irradiated onto a photomask to expose a photoresist layer. When performing photolithography processes, an un-polarized beam may be used. Although a polarized beam has a superior DOF (Depth of Focus) margin over an un-polarized beam, much of the polarized beam is lost when the beam passes through a polarization plate. Accordingly, a relatively greater amount of power must be consumed to generate a polarized beam.

### SUMMARY

According to embodiments, an exposure apparatus includes a laser oscillating part which generates an incident light. A polarization part includes at least one medium, and generates a polarized light by reflecting the incident light from the medium. A light condensing part condenses the polarized light. An exposure part exposes a wafer using the polarized light condensed by the light condensing part.

According to embodiments, an exposure method includes providing a first incident light as an unpolarized light beam from a first source of light. The first incident light beam is directed to be incident onto a polarization part at a polarization angle, in which the polarization part has at least a first medium. A first refracted light transmitted into the first medium and a first reflected light reflected from the first medium are generated using the first medium, and the first reflected light is polarized. The first reflected light is condensed using a light condensing part. The method also includes irradiating light, which is condensed in the light condensing part, onto a photomask to expose a wafer.

### DRAWINGS

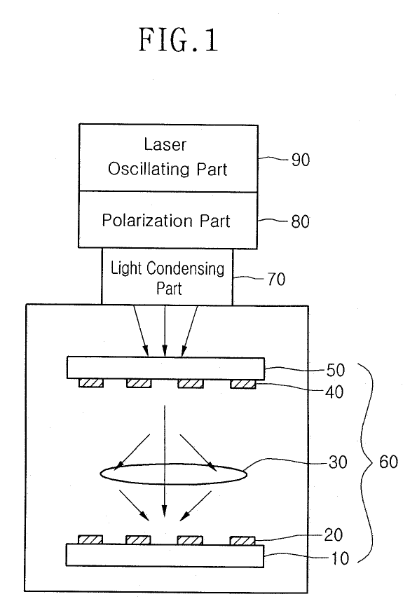

Example FIG. 1 is a view showing an exposure apparatus according to embodiments.

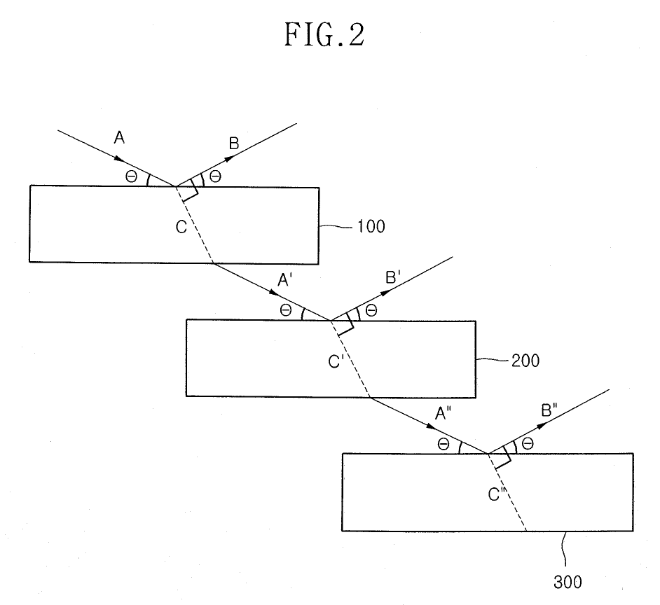

Example FIG. 2 is a view showing a polarization part to generate a polarized beam.

### DESCRIPTION

An exposure apparatus and method according to embodiments will be described with reference to example FIGS. 1 and 2. Example FIG. 1 is a view showing an exposure apparatus according to embodiments, and example FIG. 2 is a view showing a polarization part 80 to generate a polarized beam.

As shown in example FIG. 1, the exposure apparatus according to embodiments includes a laser oscillating part 90, a polarization part 80, a light condensing part 70, and an exposure part 60. The laser oscillating part 90 provides a light source used to perform a photolithography process. The light source may include a KrF light source or an ArF light source. The polarization part 80 generates a polarized beam based on the laser source.

As shown in example FIG. 2, the polarization part 80 includes first, second, and third media 100, 200, and 300, incident surfaces of which may be substantially parallel to each other. The first, second, and third media 100, 200, and 300 may be made from the same material The first, second, and third media 100, 200, and 300 may include a transparent material which has a refractive index greater than that of an air and does not absorb light. In other words, the first, second, and third media 100, 200, and 300 may include glass or acrylic. Although a polarization part 80 including three media is described, polarization part 80 may include one medium or two media, or more according to embodiments.

The light condensing part 70 condenses the polarized beam to apply the condensed polarized beam to the exposure part 60. The light condensing part 70 may include an optical fiber or a lens. The exposure part 60 exposes a wafer 10 using the beam supplied from the light condensing part 70. In the exposure part, the polarized beam passes through a photomask 50. The polarized beam is then condensed onto a projection lens 30 to be delivered to the wafer 10. Accordingly, a pattern 40 of the photomask 50 is projected onto the wafer 10 to expose a photoresist 20.

Hereinafter, an exposure method according to embodiments will be described with reference to example FIGS. 1 and 2. First incident light A provided from the laser oscillating part 90 is incident onto the first medium 100 at a polarization angle θ. The laser source of the first incident light A provided from the laser oscillating part 90 may include a KrF light source or an ArF light source. When the first incident light A is input to the first medium 100, the first incident light A generates a first refracted light C transmitted into the first medium 100 and a first reflected light B reflected from the surface of the first medium 100.

Although a laser source supplied from the laser oscillating part 90 is an un-polarized light source, the first incident light A is incident onto the first medium 100 at a polarization angle θ, and a polarized beam is generated by the first reflected light B which forms a right angle with the first refracted light C.

The polarization angle θ of the first incident light A may be changed according to a refractive index n of the first medium 100, and the polarization angle θ may be obtained through the following equation.

tan θ=n Equation 1

Accordingly, the first refracted light C and the first reflected light B generated from the first incident light A, which is not polarized, through the first medium 100 are perpendicular to each other and the first reflected light B is polarized. Accordingly, the photolithography process may be performed using the first reflected light B.

The first refracted light C having transmitted into the first medium 100 may be used as a second incident light A′ to form a second reflected light B′. When the first refracted light C having passed through the first medium 100 is incident into a second medium 200 as the second incident light A′, the second incident light A′ generates a second reflected light B′ and a second refracted light C′. The second medium 200 may be parallel to the first medium 100 with respect to an incident surface, and may be made of the same material as the first medium 100.

After the first refracted light C has passed through the first medium 100, the first refracted light C has an angle identical to the polarization angle θ related to the first incident light A. The second reflected light B′ is polarized while forming a right angle with the second refracted light C′. The second refracted light C′ having transmitted into the second medium 200 may be used as a third incident light A″.

When the second refracted light C′ having passed through the second medium 200 is incident into a third medium 300 as the third incident light A″, the third incident light A″ generates a third reflected light B″ and a second refracted light C″. The third medium 300 may be parallel to the second medium 200 with respect to an incident surface, and may be made from the same material as the second medium 200.

After the second refracted light C′ has passed through the second medium 200, the second refracted light C′ has an angle identical to a polarization angle θ related to the second incident light A′. The third reflected light B″ is polarized and forms a right angle with the second refracted light C″.

The first, second, and third media 100, 200, and 300 may include transparent material, which has a refractive index greater than that of an air and does not absorb light. In other words, the first, second, and third media 100, 200, and 300 may include glass or acrylic.

As described above, the second and third media 200 and 300 are employed so that light transmitting into the second and third media 200 and 300 is repeatedly polarized, thereby reducing the loss of light transmitting into a medium. According to embodiments, although three media are used, one medium to three media may be used. If one medium is used, an exposure process may be performed using the first reflected light B′. If two media are used, the exposure process may be performed using the second reflected light B″.

The exposure process according to the embodiment can ensure a better DOF (Depth Of Focus) margin as compared with an exposure process employing un-polarized light. The above first, second, and third reflected light B, B′, and B″ are condensed through the light condensing part 70. Then, after passing through the photomask 50, the first, second, and third reflected light B, B′, and B″ are condensed by the projection lens 30 and delivered to the wafer 10.

Accordingly, a pattern 40 of the photomask 50 is projected onto the photoresist 20 of the wafer 10 so that an exposure process may be performed. The light condensing part 70 may include an optical fiber or a lens. In the exposure apparatus and method according to embodiments, an exposure process can be performed using a polarized beam and the loss of light transmitting into a medium can be reduced.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a laser oscillating part which generates an incident light;
a polarization part which includes at least one medium, and generates a polarized light by reflecting the incident light from the medium;
a light condensing part which condenses the polarized light; and
an exposure part which exposes a wafer using the polarized light condensed by the light condensing part.

2. The apparatus of claim 1, wherein the polarization part includes a first medium, a second medium, and a third medium.

3. The apparatus of claim 2, wherein the three media include an identical material, and incident surfaces of the three media are parallel to each other.

4. The apparatus of claim 2, wherein each medium includes a transparent material which has a refractive index greater than a refractive index of an air and which does not substantially absorb light.

5. The apparatus of claim 1, wherein the light condensing part includes an optical fiber.

6. The apparatus of claim 1, wherein the light condensing part includes a lens.

7. The apparatus of claim 1, wherein the laser oscillating part includes a KrF light source.

8. The apparatus of claim 1, wherein the laser oscillating part includes an ArF light source.

9. A method comprising:
providing a first incident light as an unpolarized light beam from a first source of light;
directing the first incident light beam to be incident onto a polarization part at a polarization angle, in which the polarization part has at least a first medium;
generating, with the first medium, a first refracted light transmitted into the first medium and a first reflected light reflected from the first medium, the first reflected light being polarized;
condensing the first reflected light using a light condensing part; and
irradiating light, which is condensed in the light condensing part, onto a photomask to expose a wafer.

10. The method of claim 9, comprising:
directing the first refracted light to be incident onto a second medium as a second incident light, thereby generating a second refracted light transmitted into the second medium and a second reflected light reflected from the second medium, the second reflected light being polarized; and
condensing the second reflected light in a light condensing part.

11. The method of claim 10, comprising:
allowing the second refracted light to be incident onto a third medium as a third incident light, thereby generating a third refracted light transmitted into the third medium and a third reflected light reflected from the third medium, the third reflected light being polarized; and
condensing the third reflected light in the light condensing part.

12. The method of claim 9, wherein the polarization part includes a first medium, a second medium, and a third medium.

13. The method of claim 12, wherein the incident surfaces of the three media are parallel to each other.

14. The method of claim 13, wherein the three media include a transparent material which has a refractive index greater than a refractive index of an air and which does not substantially absorb light.

15. The method of claim 9, wherein the first incident light is incident with a polarization angle θ satisfying an equation, tan θ=n.

16. The method of claim 9, wherein the first refracted light forms a right angle with the first reflected light.

17. The method of claim 9, wherein the light condensing part includes an optical fiber.

18. The method of claim 9, wherein the light condensing part includes a lens.

19. The method of claim 9, wherein the polarization part includes a first medium and a second medium.

20. The method of claim 19, wherein the incident surfaces of the two media are parallel to each other.
